(19) United States
(12) Patent Application Publication
(10) Pub. No.: US 2008/0096605 A1
(43) Pub. Date: Apr. 24, 2008

(54) DISCOVERY AND DELIVERY OF RICH MEDIA CONTENT TO A PERSONALIZED MOBILE MEDIA BOX

(76) Inventors: Itay Gissin, Ramat Hasharon (IL); Nimrod Reich, Tel Aviv (IL); Avinoam Zakai, Shavana (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 11/876,083

(22) Filed: Oct. 22, 2007

Related U.S. Application Data
(60) Provisional application No. 60/862,280, filed on Oct. 20, 2006.

(51) Int. Cl. H04M 1/00

(52) U.S. Cl. 455/556.2

(57) ABSTRACT

Content is provided to a mobile device by selecting or defining content criteria at a content provisioning system platform, obtaining the content associated with such selections or definitions, converting the content into an appropriate format, and then making the content available for download to the mobile devices. The content can be pushed, such as by sending the content to a mobile device, or the content can be pulled by the mobile device accessing the system and requesting the content.

### CROSS-REFERENCE TO RELATED APPLICATIONS

This application is a non-provisional application filed under 37 CFR 1.53(b) and 35 USC 111(a) claiming the benefit of the provisional application filed under 35 USC 111(b) on Oct. 20, 2006 and assigned Ser. No. 60/862,280, which application is hereby incorporated by reference.

### BACKGROUND OF THE INVENTION

The present invention relates to the field of mobile media, and more particularly to the delivery of content from the Internet and improving the accessibility to content by reducing the amount of user intervention required and also be removing barriers accessing the content.

Accessing the Internet using a mobile telephone is increasing in popularity as the ability to obtain information in mobile manner is improved through advancements in technology. However, it is appreciated that those accessing the internet using a mobile telephone are limited by several factors, one such factor being the user interface provided by the mobile telephone and lack the diversity of options for retrieving content. Users that attempt to download content from the Internet to a mobile device can do it in one of the following ways:

(1) Access dedicated sites that have substantially limited offerings compared to what is available to other users accessing the Internet using standard browsers operating on a computer; or

(2) Download content to a personal computer (PC), convert the content to mobile format (if they have the knowledge of how to do so and the necessary tools) and connect the PC to the mobile telephone via a dedicated cable or short range wireless communication protocol (in many cases special hardware is required for the PC)

After performing all of the above-enumerated steps listed under option (2), the data can be transferred to the local memory within the mobile telephone. The size of this data transfer is small relative to the sizes of media items such as audio(music) and video files.

Also, if the user desires to update the content on his mobile telephone, he will have to repeat the process described above over and over for each updating process.

Mobile networks are evolving rapidly and it is expected that ultimately, they will provide full broadband rates or better in the near term. Once such service levels are available, it will be easier and more cost effective for an end user to consume data upon demand (using streaming technology) rather than storing it locally on the device and using the above-described tedious process to gain access to that data on a mobile telephone.

Thus, until mobile network technology attains this goal, it is evident that current technologies of mobile media delivery, especially when accessing Internet content, create significant difficulties in providing users with the experience they are used to in the traditional way (such as a browser running on a computer). Therefore, there is a need in the art for new techniques for the delivery of Internet based content to mobile users. Furthermore, there is a need for a new method for delivering content from personal user data sources (personal computers, personalized web sites for example) to mobile devices.

### BRIEF SUMMARY OF THE INVENTION

The various embodiments, aspects and features of the present invention address the above-identified needs in the art, as well as other needs by providing a system and method for defining, identifying, storing, converting and delivering content to a mobile device in a user friendly and efficient manner.

Embodiments of the present invention enable users to define their content interests by providing or entering keywords in a regular web environment. Embodiments of the system can, in response to such keywords:
(a) Crawl via multiple web sites and web search engines;
(b) Discover relevant rich media content
(c) Convert and adapt the content for the mobile environment of a mobile user (phone model, screen size, network type and conditions).
(d) Store the adapted content or the original web link in a personal storage and portal for the user.

Thus, content is provided to a mobile device by enabling a user to define his\her area of interest (AOI) via any PC connected to the internet, and allow the AOI to be modified from time to time. Content is then searched for, identified, acquired and prepared according to the AOI (i.e., based on keywords), updated periodically and adapted to the specific mobile environment of the user. The content can take on a variety of forms including music or audio files, video content, data files, media files, graphics, photos, or the like.

More specifically, one embodiment of the present invention includes a technique for delivering content to a mobile device. Initially, a user access a content provisioning system from a terminal, such as a personal computer, dumb terminal, smart terminal, or the like. Using the terminal, the user enters information to define the content to be delivered to the mobile device. The definition can take on a variety of forms including key words, categorizations, themes, or the like, but in general operates to establish a search criteria for identifying content. Based on the definition, a search is conducted. The search may include a search of the Internet through crawling and/or using commercial, proprietary or manual searching techniques, as well as searching local databases and other sources. Once content that falls within the parameters of the definition is identified, the content is converted, if necessary, into a format suitable for delivery of the content to a mobile platform. Upon receiving a request to transfer the content to the mobile device, the content, or data associated with the content is transferred to the mobile device.

Embodiments of the present invention can incorporate usage-based personalization. This aspect of the present invention involves analyzing actual behavior of a user on the site (the web portal and/or the mobile portal). This aspect of the invention advantageously enables for better filtering and matching of content to users' channels. This aspect of the invention may also include the monitoring of user feedback regarding specific channels, clips and/or content. This feedback information is utilized to learn about preferred content sources and channel types (current vs. relevant content). Another aspect of the invention is a community-based recommendation feature. This is based upon segmentation of users based on areas of interest and contextual analysis of different taxonomies on the service. An example is a user that created a Liverpool channel (sports) being offered an Oasis channel (music), based on the real-life contextual link between the two, or the fact that other users of this channel have also viewed the other channel. More specific segments can be built around affinity groups and actual niche interest areas can encourage viral distribution between peers (Fan clubs).

One aspect of the invention also includes the ability to enter, along with the information to define the content, information to define the destination mobile device. Such information is used in performing the conversion of the content to the proper format.

In various embodiments, the content can be transferred to the mobile device as a result of one or more actions. One such action includes requesting the transfer from the terminal. Another such action includes providing a request to the content provisioning system from the mobile device itself. Furthermore, in response to such a request, the actual content can be delivered to the mobile device or, simply a link or reference to the actual content can be delivered. In addition, in some embodiments, the request may be followed by a content update process prior to performing the actual transfer. In addition, autonomous from a transfer request, the content may be augmented by performing an additional search to identify if any content has changed or if additional content is available.

Another aspect of the present invention includes the ability to upload content to the content provisioning system from the terminal or some other computing device. In one embodiment, content definitions can be provided to the content provisioning system which, in response, searches the terminal for content meeting the definition. This content is then uploaded to the system. Furthermore, some embodiments may include the ability to monitor the terminal for the presence of additional content that meets the definition. The uploaded content can then be adapted to a format appropriate for the destination mobile device.

Another aspect of the invention includes not only searching the Internet for content but also searching content that has been previously uploaded to the system, downloaded from the Internet, or is otherwise available from one or more terminals, databases or system communicatively coupled to the content provisioning system.

Another embodiment of the present invention includes a system for obtaining and delivering content to a mobile device. The system includes a web portal to serve as a user interface for receiving channel definitions. In addition, the system includes a mobile portal to serve as a mobile device interface. A user and content management unit is communicatively coupled to the web portal and the mobile portal, and operates to receive a content or channel definition and then generate one or more search requests based on the received channel definition. The search requests are then provided to a crawler which is communicatively coupled to the user and content manager unit and the Internet. The crawler conducts searches in accordance with the search requests to obtain content for the defined channel. A mobile adaptation unit is communicatively coupled to the crawler and it is operative to receive content from the crawler and then adapt the content to be compatible with the destination mobile device. The content is then provided to the user and content management unit as channel content for storage in a mobile content database and/or transferring to a mobile device through the mobile portal. The system can also receive uploaded content from an external terminal and/or search external sources, such a terminal, for uploadable content that meets certain definition criteria.

Other embodiments, aspects, features and advantages of the present invention will become apparent upon reading the following detailed description.

### BRIEF DESCRIPTION OF THE SEVERAL VIEWS OF THE DRAWING

FIG. 1 is a block diagram illustrating various system components and the types of information/control flow and interaction between the various system components in an exemplary embodiment of the present invention.

FIG. 2 is a flow diagram illustrating the steps involved in the operation of an exemplary embodiment of the present invention.

FIG. 3 is a flow diagram illustrating an on-demand channel update process.

FIG. 4 is a flow diagram illustrating a periodic channel update process.

FIG. 5 is a flow diagram illustrating the steps involved in one embodiment of personal data configuration and upload process being preformed by an embodiment of the Syncho client.

FIG. 6 is a flow diagram illustrating an embodiment of an aspect of the invention pertaining to accessing uploaded personal data from a mobile device.

### DETAILED DESCRIPTION OF THE INVENTION

The present invention, as well as features and aspects thereof, is directed towards providing an improved and user centric method and system for downloading or delivering content to a mobile device.

Turning now to the figures in which like numerals represent like elements throughout the several views, exemplary embodiments, features and aspects of the present invention are described. For convenience, only some elements of the same group may be labeled with numerals. The purpose of the drawings is to describe exemplary embodiments and not for production. Therefore features shown in the figures are chosen for convenience and clarity of presentation only, although the illustrated features may be considered as novel components of an embodiment of the invention.

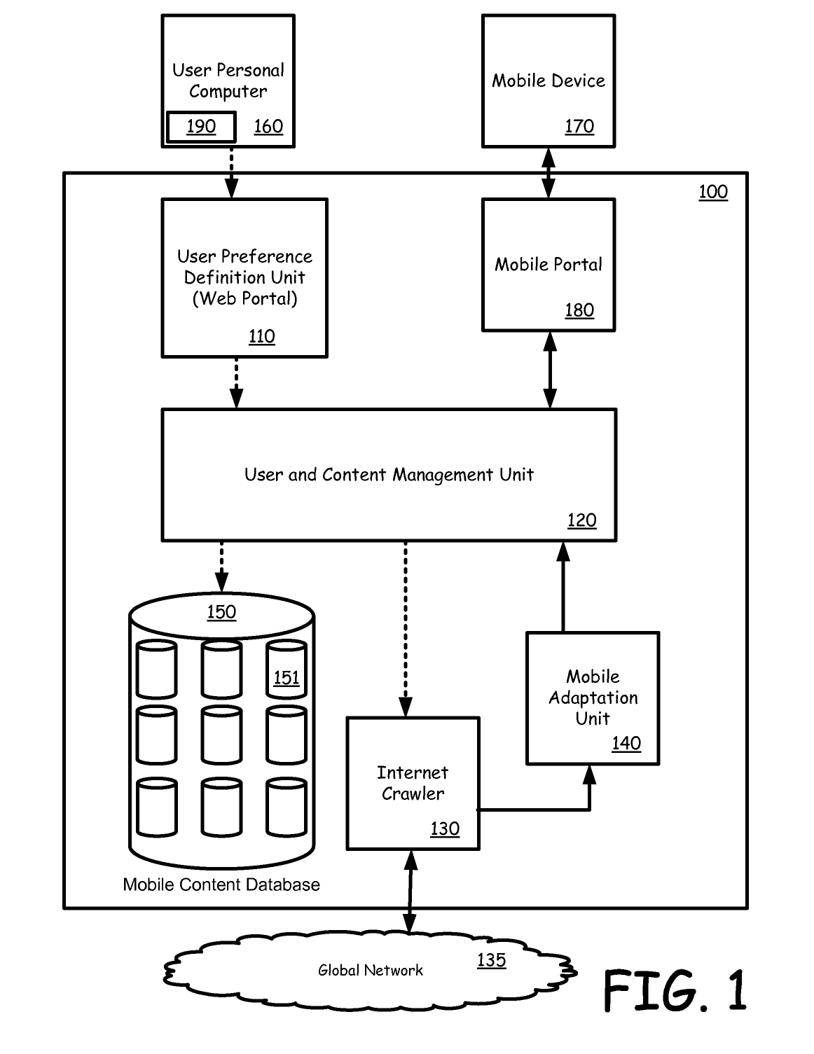

FIG. 1 is a block diagram illustrating various system components and the types of information/control flow and interaction between the various system components in an exemplary embodiment of the present invention. Although the illustrated structure may in and of itself be considered a novel aspect of the present invention, it should be appreciated that the present invention is not to be limited to the illustrated configuration and that various functions, capabilities and processes described may actually be housed in different blocks or spread across multiple blocks. As such, the present invention is not limited to the illustrated structure.

In general, the illustrated system 100 manages and stores content in a personal media box 151, which content can be accessed by a user on a personal computer 160, but that is ultimately to be accessed by a user's mobile device 170. A media box 151 is provided for each user of the system 100 is illustrated as being housed in a storage facility or element 150. One aspect of the invention is to allow the user to share content or portions of the content that are stored in his or her personal media box 151. The content stored in the media box 151 is personalized, at least according to user definitions, selections and preferences, and is also adapted or adaptable to the specific mobile device(s) that is(are) associated with the user or user account.

Utilizing a user personal computer 160 or other source (such as a smart terminal, dumb terminal, or other client device), the user can identify or define areas of interest and provide information according to these areas of interest to the user preference definition unit (web portal) 110. In addition, utilizing a mobile device 170, the user is able to access, receive and/or consume data via the mobile portal 180.

The content is organized by area of interest and each area of interest that is defined by the user is referred to as a channel. The content can be received or acquired from various sources, including as non-limiting examples, the world wide web or Internet, personal computers or any other shared data repository locations.

More specifically, the system 100 includes a mobile portal 180, a user preference and definition unit 110, a user and content management unit 120, an Internet crawler 130, a mobile adaptation unit 140, a personal media box database 150 and a personal computer or computing device 160, running a Syncho client 190.

The personal media box database 150 houses personalized media boxes 151 for each user of the system 100. Each personal media box 151 includes the content and\or links to content items that have been stored by or for the user. The personal media box database 150 also includes user information, including but not necessarily limited to, the user name, user password, user mobile device of mobile telephone type, last access time etc.

The user and content management unit 120 operates to retrieve and store content and user information from the personal media box database 150. Thus, the user and content management unit 120 effectively provides an interface to the personal media box database 150 that is utilized by all other system components and modules, as necessary.

The Internet crawler 130 operates to search the Internet through various means and procedures, including activating third party search engines, using proprietary or customer search engines, manual searches or by searching a pre-defined list of sites. For example, in one embodiment of the present invention, the Internet crawler 330 receives a specific term as its input and returns links and the specific content of the search focused on that specific term.

The mobile adaptation unit 140 operates to receive content from the Internet 135 via the Internet crawler 130 and then converts the received content to formats that are supported by mobile devices 170, such as a formats defined by the 3GPP container, MPG4, AMR and/or AAC encoding methods.

The mobile portal 180 serves as the user's mobile device 170 access to the data or content by presenting a web based interface to the content housed in the personal mobile media box 151.

The user preference and definition unit 110 serves as the interface for defining personal data that is used by the user and content management unit 120. The personal data defined through the user preference and definition unit 110 includes, as non-limiting examples, each of which may in and of themselves be considered as novel aspects, although not required aspects of various embodiments of the present invention:

Web channels: This type of personal data consists of user defined terms or descriptions of various categories of content that are provided to the system 100. For instance, a user can define a channel using the terms “James Taylor” to access videos, audio, other channels and other content related to James Tayler. Similarly, a user can define a channel using the terms “James Taylor” “audio” “live” to contain James Taylor music that was recorded live. Thus, the user can define a channel based on these criteria, as well as required content times, content themes, preferred sources, etc. The system 100 operates to conduct periodic Internet searches based on the defined terms for each channel, and delivers updated results of media content related to the defined terms.

Publish and share channels: This type of personal data includes channels that the user chooses to publish to specific users or make it available to large groups of users.

The personal computer 160 houses and serves as a platform for the Syncho client 190. The Syncho client 190 serves as an automatic upload engine to the user preference definition unit 110. The Syncho client 190 can detect new media items that have been loaded on, entered into or made accessible to, the user PC 160 and then operate to upload them automatically the system 100 where it will be processed and become available via the mobile device.

The mobile device 170 can be any of a variety of devices, including laptop computers, cellular telephones, digital telephones, satellite telephones, cable set-top boxes, PDA, pocket computers, or the like. Communication to the mobile device is performed wirelessly and can depend upon the service provider for the mobile device. For instance, a cellular telephone may communicate over the 3G network or other digital cellular network. A personal commuter may communication over a Bluetooth or WIFI connection.

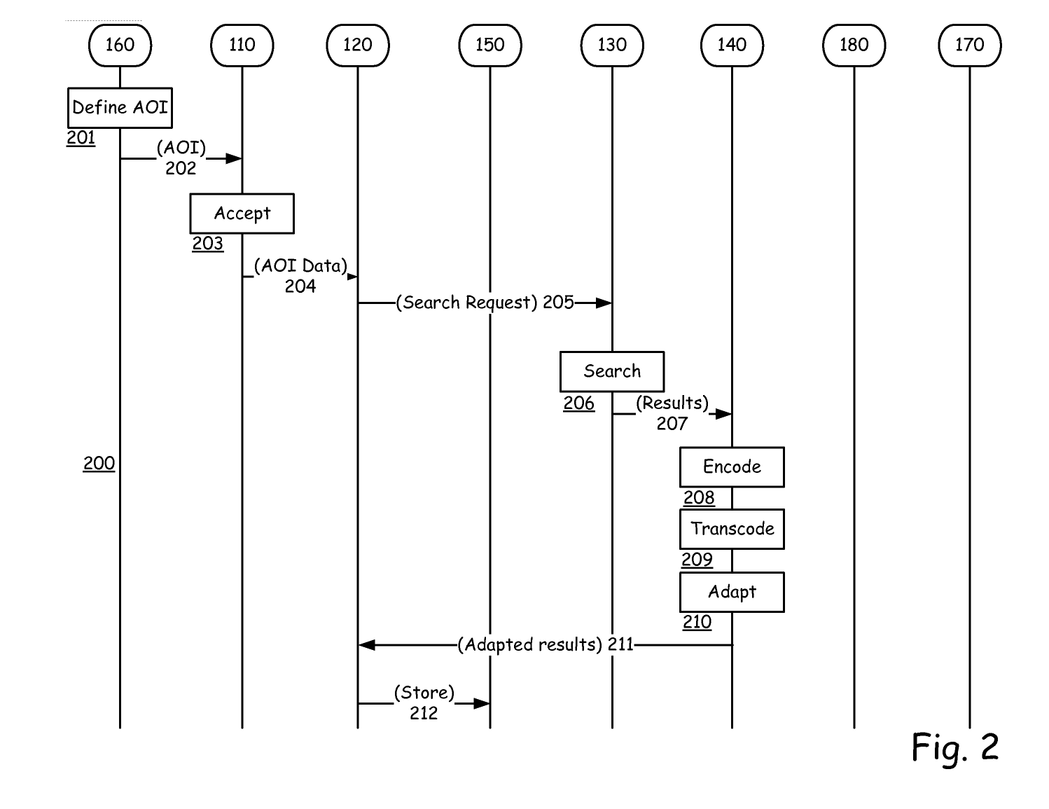

A further understanding of the various embodiments, aspects and features of the present invention can be obtained listing the various operations that occur in delivering content to a mobile device 170. FIG. 2 is a flow diagram illustrating the steps involved in the operation of an exemplary embodiment of the present invention. At the onset of the operation, a first time definition process 200 is performed. The first time definition process 200 is initiated by the user operating a personal computer or other computing source 160 accessing the web portal 110 and defining the areas of interest (AOI) 201. This step involves the provision of data from the user PC 160 to the user preference definition unit or web portal 110. By exercising a user interface resident on the user PC 160 or displayed on the user PC 160, such as in a browser window rendering information received from the web portal 110, the user enters or selects items to define an AOI. The entered or selected items generate data that is delivered 202 to the web portal 110. Once the data is accepted and processed 203 by the web portal 110, the data or variants thereof is passed to the user and content management unit 120 where the data is stored and maintained for storage and management 204.

The user and content management unit 120 then initiates a request 205 to the Internet crawler 130 with data that identifies the specific areas of interest that the user has defined. In response to this request, the Internet crawler 130 searches or crawls the Internet by accessing a list of predefined sites, search engines or even by being manually manipulated to search specific locations 206.

The results of the Internet crawler 130 search are passed 207 to the mobile adaptation unit 140. The mobile adaptation unit 140, in response to receiving the search results, performs the following operations:
(a) Encoding the content for compatibility with the intended the mobile device 208. This process involves converting the data from the various Internet formats in which that searched content was found, such as AVI, WMV, WMA, etc, into a format compatible with the mobile device 170, such as the 3GPP format as a non-limiting example.
(b) Transcoding the content 209. The content transcoding process involves adjusting the required bit rate for the transmission of the data to a bit rate that is compatible with the mobile network to which the mobile device 170 is associated.
(c) Adapting the image to the screen size of the mobile device 210. Various mobile devices may have different screen sizes, display resolutions, capabilities etc. As such, the mobile adaptation unit 140 must also make adjustments to the data based on the display characteristics of the destination mobile device 170.

Upon completion of the adaptation operation, the mobile adaptation unit 140 passes the results to the user and content management unit 120 at step 211. The content management unit 120 then provides the adapted data for storage into the mobile content database 150 along with the user details 212. Thus, the adapted data is then readily available in the mobile content database 150 for provision in response to future mobile access requests. The data available in the mobile content database for the defined area of interest is referred to as a channel.

Embodiments of the invention also provide for a channel update process. In the channel update process 220, an update process is defined for each user having a valid list of channels. The channel update process can take on two forms (a) on-demand updating or (b) periodic updating. It should be appreciated that embodiments including this aspect of the present invention can implement one or both of these techniques.

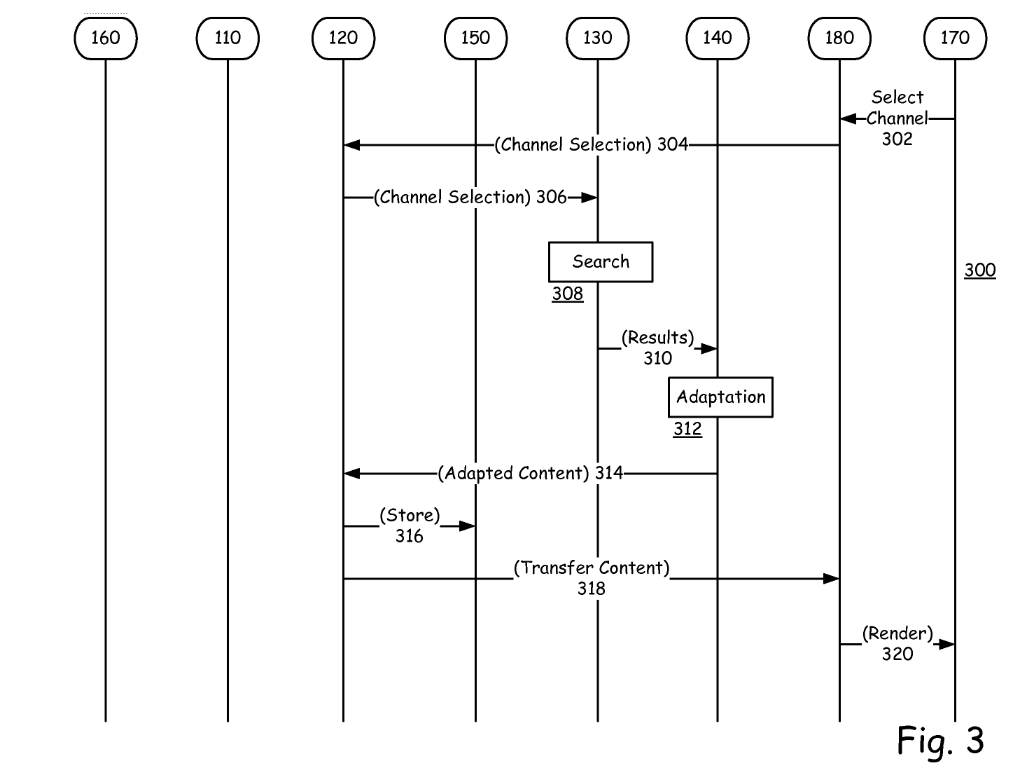

FIG. 3 is a flow diagram illustrating an on-demand channel update process. For an on-demand channel update process 300, the user, utilizing the mobile device 170, logs into the mobile portal 180 and selects a specific channel 302. The selection is passed 304 to the user and content management unit 120. In turn, the user and content management unit 120 passes the selection to the Internet crawler 130 for data retrieval 306. The Internet crawler then performs a search 308. The results of the search, which typically is updated, modified or new content) are passed 310 to the mobile adaptation unit 140 for online adaptation 312 (which may include encoding, transcoding and adapting as described above) and the adapted content is then returned 314 to the user content and maintenance unit 120. The user content and maintenance unit 120 then stores the adapted content 316 in the mobile content database 150 and/or transfers the adapted content 318 to the mobile portal 180. The content can then be delivered to or accessed by to the mobile device 170 and rendering to the user 320. In should be noted that in a typical embodiment, the whole on-demand channel update process 300 is performed online (as opposed to the below-described periodic update process). However, it should also be appreciated that in some embodiments, the user may initiate the process from an offline state, such as by sending an email, text message, etc., and the update would subsequently run autonomously in an offline manner.

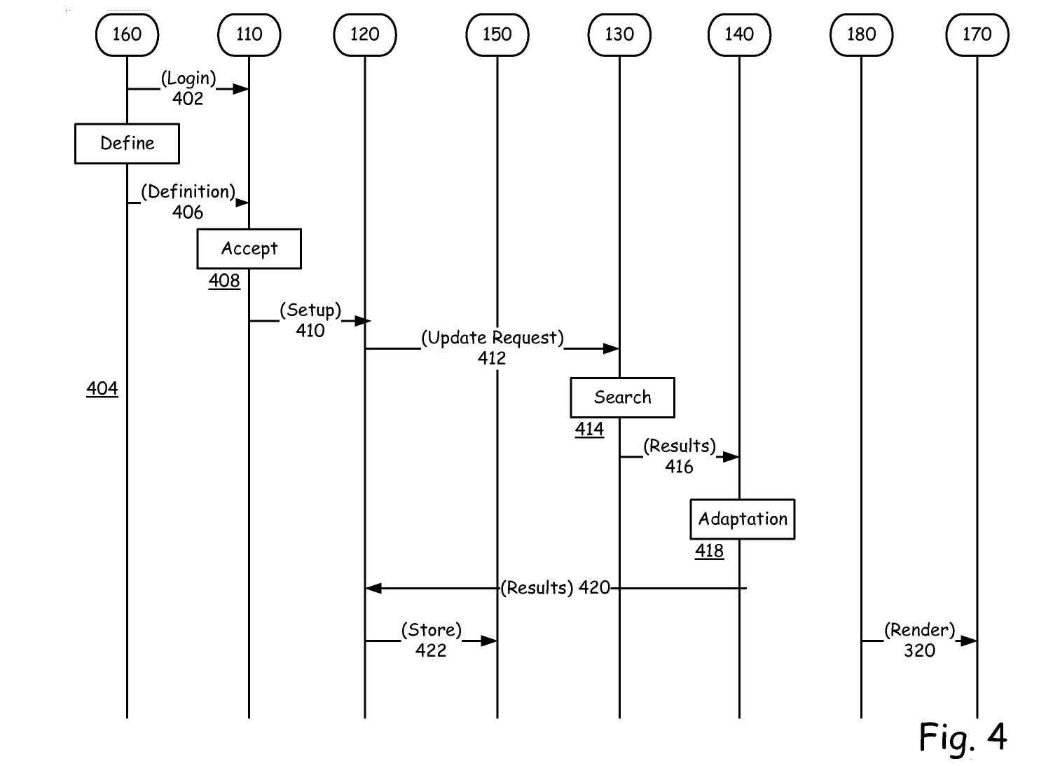

FIG. 4 is a flow diagram illustrating a periodic channel update process. The periodic update process 400 is initiated by the user accessing 402, such as logging into, the content management unit 120 via user PC 160 rather than a user action on the mobile device 170. The user can then define 404 the periodic update schedule for all content or selected content. The definition is then provided 406 to the web portal 110 for verification and acceptance 408. Once accepted 408, a setup request 410 is delivered to the user content and management unit 120 to establish the periodic update schedule. Once the periodic update schedule (or schedules) is established, the system can autonomously and periodically perform the update process. Once active, the periodic channel update process 400 is commenced by the user content and management unit 120 sending a request 412 to the Internet crawler 130 identifying the specific areas of interest for the user. The Internet crawler 130 then proceeds to crawl or search the Internet and/or other sources by accessing a list of predefined sites 414. The results of the search are passed 416 to the mobile adaptation unit 140. Upon reception of the search results, the mobile adaptation unit 140 performs the following data adaptation operation 418 which may include:
(a) Encoding the content for compatibility with the intended the mobile device. This process involves converting the data from the various Internet formats in which that searched content was found, such as AVI, WMV, WMA, etc, into a format compatible with the mobile device 170, such as the 3GPP format as a non-limiting example.
(b) Transcoding the content. The content transcoding process involves adjusting the required bit rate for the transmission of the data to a bit rate that is compatible with the mobile network to which the mobile device 170 is associated.

Upon completion of the periodic update process 400, the operation of adaptation is completed and the mobile adaptation unit 140 will pass the results 420 to the user and content management unit 120, which in turn will cause the adapted data to be stored 422 in the user personal media box 151 of the mobile content database 150. Subsequent to this process, the content can be provided to the user if he attempts to access the mobile portal. It should be appreciated that the frequency of the periodic update 400 can be specified for each user and/or for each channel and can vary over a wide range.

Another aspect of the present invention, which in and of itself may be considered novel but is not a required aspect of all embodiments of the present invention, is the ability to upload personal data from the user PC 160. Personal data stored in the user PC 160, inserted into the user PC 160 such as on a CDROM, memory stick, etc., or made accessible by the user PC (i.e. through an external drive, remote drive, network or service system), can be uploaded to the personal media box 151. When storing such personal data into the personal media box 151, or upon subsequently attempting to access the personal data from a mobile device 170, the personal data is adapted to the mobile device 170. Thus, advantageously the user can view and/or listen to this personal data via the mobile device 170 on demand as well.

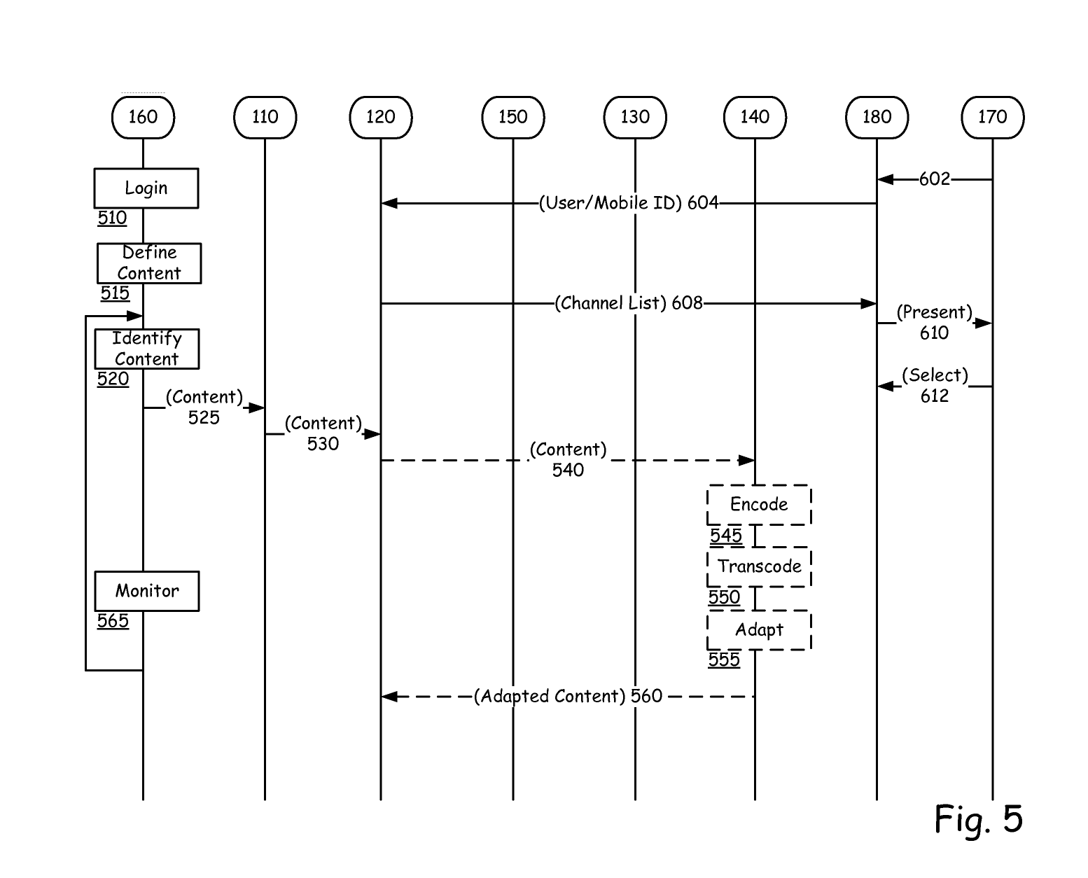

FIG. 5 is a flow diagram illustrating the steps involved in one embodiment of personal data configuration and upload process being preformed by an embodiment of the Syncho client 190. In operation, the user can login 510 and define the content 515 that will be uploaded to the personal media box and adapted to mobile. The definition can be based on a variety of information, such as but not limited to, content type and/or folders and/or file names for the items. The Syncho client 190 running within the user PC 160 identifies the available content 520 based on the provided definitions, accesses and then uploads 525, along with user identification information and content definitions to the web portal 110. The web portal 110, after processing and verifying the information, transfers 530 the content and/or sufficient information to identify the content to the user content and management unit 120. The user and content management unit then stores the content 535 within the media box database 150. Alternatively, in some embodiments, prior to storing the content in the media box database 150, the content is passed 540 to the mobile adaptation unit 140 to be encoded 545, transcoded 550 and/or adapted 555 in view of the destination mobile device 170, and then transferred back 560 to the user content and management unit 120. In other embodiments, the data may simply be stored 535 until requested by a mobile device 170 and at that time, the data can be transferred to the mobile adaptation unit 140 for adaptation in view of the destined mobile device 170. The Syncho client 190 then continuously monitors for new content that coincides with the definition 565 and then returns step 520 to again identify and upload the content once new or modified content is detected.

As a non-limiting example, a user may enter a request for his or her audio MP3 files to be uploaded to the media box 150. The user may define the eligible MP3 files by defining a particular folder in which the audio MP3 files are located. Subsequently, whenever the user stores a new audio MP3 file into this folder, the Syncho client 190 uploads the MP3 file to the media box. As another example, the user may define all MP3 content that has a creation date on the PC of less than 1 week old and that has not already be uploaded to be uploaded to the media box. Similarly, the user can define the content by artist, album, genre, etc. Similarly, the content may also include data files, video files, graphic stills, photographs, ring tones, snippets, etc.

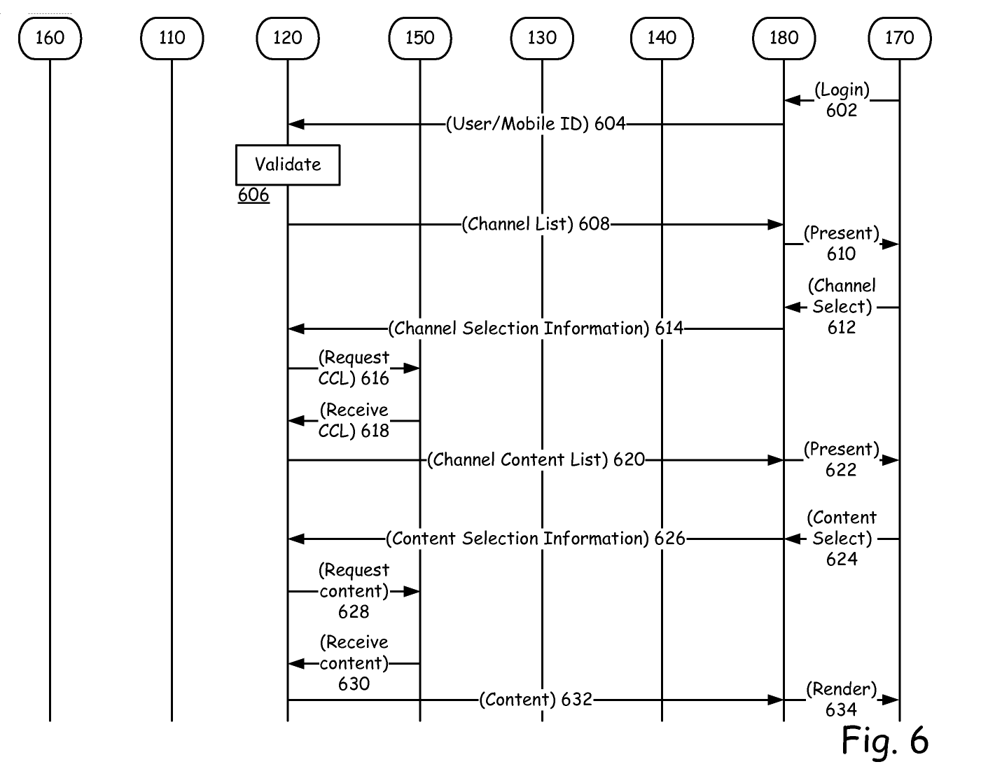

FIG. 6 is a flow diagram illustrating an embodiment of an aspect of the invention pertaining to accessing uploaded personal data from a mobile device. The user accesses the personal data using a mobile device 170 by first gaining access to the mobile portal 180. The user may gain access to the mobile portal 180 by providing a user name and password to login 602. Other techniques may also be used such as examining the mobile station number, device codes, etc. The mobile portal 180 then sends the user details or sufficient information to identify the user 604 and/or mobile device 170 to the user content and management unit 120. The user content and management unit 120 operates to validate the user and if valid, returns a list of channels and/or content identifies 608 to the mobile portal 180 for presentment to the user 610 on the mobile device 170. It will be appreciated that in some embodiments, rather than providing the channels and/or content identifiers, the downloading of the content itself can be immediately commenced at this point.

Using the interface on the mobile device 170, the user can select a channel and/or content identifier 612. The selection information is passed 614 by the mobile portal 180 to the user content and management unit 120. The user content and management unit 120 then requests the channel content list (CCL) 616 from the mobile content database 50 and then receives 618 the channel content list from the mobile content database 150. It will be appreciated that the relationship between the user content and management unit 120 and the mobile content database 150 may be less formal and instead of including a request and receive process to obtain the channel content list, the user content and management unit 120 may simply retrieve the channel content list from the mobile content database 150. In either case, the user content and management unit 120 then transfers 620 the channel content list to mobile portal 180 for presentment to the user 622 via the mobile device 170. At this point, the user can select specific items in the channel content list 624 that he or she would like to consume via a streaming service or a download service. This content selection is provided to the mobile portal 180 which then transfers content selection information 626 to the user content and management unit 120. Again, it will be appreciated that rather than sending a channel content list to the mobile device, other embodiments of the invention may commence the downloading of the content to the mobile device and allow the user to select particular items that are resident on the mobile device rather than as a link to the content still stored within the system 100.

The user content and management unit, upon reception of the content selection information 626, accesses 628 the mobile content database 150 and retrieves 630 the selected content that has been prepared in the periodic update or first time search. In the case of online updating, rather than accessing the mobile content database 150, the user content and management unit 120 will pass the request with the appropriate metadata for retrieval from the Internet crawler 130 and online adaptation by the mobile adaptation unit 140. Finally, the selected content is then transferred 632 to the mobile portal 180 and can then be rendered 634 to the mobile device 170.

A user can access the content from the system 100 by accessing the system 100 through the mobile portal 180 to pull the content, or the content can be pushed to the mobile device 170. To pull content, the user simply uses the mobile device 170 to gain access to the mobile portal 180. Such access may require a user name and password, but may include other information in addition to the user name and password or in place thereof. Once logged into the mobile portal 180 or simply connected to the mobile portal 180, the user can then select available content and either initiate a download or commence a streaming of the content to the mobile device. To push content, the user can access the system through the web portal 110, identify content, categories of content or channels, and the select to have the content pushed to the mobile device. For instance, if the user enters the mobile number, the type of device and/or the service provider, the system can then appropriately adapt the content and send it to the mobile device. Alternatively, the system may simply send an email or text message to the mobile device with the message including links to the content located on the system 100. In yet another embodiment, a user may push content to the mobile device by directly accessing a web site that serves as a front end to the system 100 or, that implements an embodiment of the present invention. In the former embodiment, the user can surf and search to identify content, preview the content, listen to the content, etc., and then, if desired, select to have the content pushed to the mobile device 170. The content would then be processed through the system 100 and transferred or made available to the mobile device. In the latter embodiment, the website includes an embodiment of the present invention and as such, can process and adapt the content upon selection and transfer or make available the content for the mobile device 170.

In a specific embodiment of the present invention, such as the one available on the website located at hooqs<dot>com, a content accuracy system provides the ability to pin-point the portion of content that is most likely to match the user's personal preferences and the content that is most likely to match mobile consumption. The content is collected off source media sites, using RSS feeds, video search engines, and site search functionality. Out of all the available content, the accuracy engine uses a combination of parameters taken from the media itself (e.g. duration), available metadata describing the media (e.g. tags) and usage data collected from the www.hooqs.com web portal and mobile portals.

All matching media is ranked according to the parameters above, factoring different parameters in different weights, and normalizing according to specific site parameters (preferring “quality” sources). Real-time, DSP based conversion and streaming of data to the user can add better performance for a greater number of concurrent users, while eliminating the need of caching and pre-fetching of content. An added value of a DSP based solution is the ability to track the actual user experience, which is prawn to different network conditions and to user specific device capability, data plans etc.

Integrating the data that is collected from overall traffic analysis for a user gives rise to the ability to:
a) Match specific content that will most likely play better for a specific user and specific device; and
b) Dynamically adjust encoding parameters to match actual network capabilities and behavior, in order to boost user experience.

Personalization is achieved by tracking user preferences and interest areas and using a taxonomic database and a learning system mechanism. The selection of content becomes more in-tune with the specific taste of users as users will consume and comment on more media through the site.

In one embodiment of the invention, media content can be ranked based on accuracy parameters. For instance, the accuracy parameters can include three categories:

Content Attributes
Duration—looking for specific play length of certain media (for instance up to a 150 seconds limit)
Resolution—preferring higher resolution media over lower resolution.
Motion analysis parameter—preferring higher motion parameter value for higher resolution media.
Media delivery method—preferring progressive download media over streaming media.
A/V format—preferring specific media types and encodings.
Syncho content preferences—preferring specific media sources (quality considerations, information integrity, content promotion agreements etc.)

Content Metadata
Clip name and description—look for best textual and taxonomical match with the query.
Tags—look for best textual and taxonomical match with the query.
Category—provides another layer of semantic data about the media.
Ranking—prefer higher ranking medias.
Popularity—prefer higher view count of a media—this factors in total site popularity compared to other source sites.

User Feedback
Hooqs.com collected metadata—use the content tags, categories and channel in local hooqs.com catalogue.
Community ranking of medias and channels.
User's areas of interest and usage patterns—every time a user is creating, watching, ranking, tagging or
   adding any content the system learns it and adds the data to the total ranking of media.
Actual network traffic data—User will get the media most likely to play better on his or her device.
Personal Usage Patterns
Frequency of use—the more the user uses the more diversified the presented selection.
Choice of recent vs. highest ranked content—will tilt contents towards that blend.
Viewing time per clip on mobile—will impact number of clips and diversity in length.
Related channels—will impact taxonomic filtering.

An exemplary ranking algorithm factors in all the parameters above. The weight of each parameter can vary from embodiment to embodiment and can be decided upon empirically or arbitrarily. For instance, in one embodiment, over time the weight given to each parameter can be adjusted to values that give better overall results. For example, the popularity of certain media is more important than the ranking of that media.

Below is an example of actual weight in % of metadata parameters:

| Parameter | Weight % |
|---|---|
| Popularity | 18.66 |
| Ranking | 10 |
| Video file size | 14.28 |
| Clip duration | 18.56 |
| Media file Type | 14.28 |
| Media description match | 10 |
| Media name match | 14.28 |

Overall, this invention improves the delivery of content from the Internet to mobile devices. The present invention reduces the need for additional equipment and or software. Furthermore the present invention discloses a method and an apparatus for delivering personalized content to users on demand.

The result is streamlining the process of delivery for the end user by using a central personal media box and on demand delivery.

Mobile operators will benefit from increase usage of data services by leveraging the endless amounts of content that reside or or is available through the Internet and the ability to deliver adapted content according to the user definition.

In the description and claims of the present application, each of the verbs, “comprise” “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

What is claimed is:

1. A method for delivering content to a mobile device, the method comprising the steps of:
accessing a content provisioning system from a terminal;
entering definition information via the terminal, the definition information at least including content definition for content to be delivered to a mobile device;
searching a global network for content, the search being at least partially based on the content definition;
converting at least a portion of the content identified in the search to a mobile device format;
receiving a request to transfer the content to the mobile device; and
transferring data associated with the content to the mobile device.

2. The method of claim 1, wherein the step of entering definition information via the terminal further comprises entering mobile device definition to identify the destined mobile device and, the step of converting at least a portion of the content further comprises converting the at least a portion of the content to a mobile device format compatible with the destined mobile device.

3. The method of claim 1, wherein the step of transferring the content to the mobile device is the result of a step comprising providing a request from the terminal, the request being a request to transfer the content to the mobile device.

4. The method of claim 3, wherein in response to the request to transfer the content to the mobile device, the step of transferring data associated with the content to the mobile device comprises sending links to the content.

5. The method of claim 3, wherein in response to the request to transfer the content to the mobile device, the step of transferring data associated with the content to the mobile device comprises sending the content.

6. The method of claim 1, wherein the step of transferring the content to the mobile device is the result of the steps comprising:
accessing the content provisioning system from the mobile device; and
using the mobile device to request the transfer of the content to the mobile device.

7. The method of claim 1, further comprising the steps of:
receiving a request from the mobile device to access the content;
in response to the request, conducting another search for additional content; and
converting at least a portion of the additional content identified in the search to a mobile device format and including it with the previously obtained content.

8. The method of claim 1, further comprising the steps of:
periodically conducting another search for additional content; and
converting at least a portion of the additional content identified in the search to a mobile device format and including it with the previously obtained content.

9. The method of claim 1, further comprising the steps of:
receiving an upload request from the terminal; and
uploading content from the terminal into the system.

10. The method of claim 9, further comprising the step of searching the system for content, the search being at least partially based on the content definition.

11. The method of claim 9, further comprising the step of monitoring the terminal for additional content to be uploaded.

12. The method of claim 1, further comprising the steps of:
providing upload definitions via the terminal;
searching the terminal to identify content conforming to the definitions; and
uploading content from the terminal into the system.

13. The method of claim 12, further comprising the step of monitoring the terminal for additional content that conforms to the definitions and then uploading the additional content.

14. The method of claim 13, further comprising the step adapting the uploaded content into a mobile device format.

15. The method of claim 1, wherein the step of searching a global network for content further comprises searching a predefined list of Internet sites and using pre-selected search engines.

16. A system for obtaining and delivering content to a mobile device, the system comprising the components of:
a web portal to serve as a user interface for receiving channel definitions;
a mobile portal to serve as a mobile device interface;
a user and content management unit communicatively coupled to the web portal and the mobile portal, and which is operable to receive a channel definition and generate one or more search requests based on the received channel definition;
a crawler, communicatively coupled to the user and content manager unit from which it receives one or more search requests and in response to each such search request, conducts searches in accordance with the search requests to obtain content for the defined channel;
a mobile adaptation unit communicatively coupled to the crawler from which it receives content, adapts the content to a mobile device format and provides the adapted content to the user and content management unit as channel content; and
the user and content management unit being operative to transfer at least a portion of the channel content to a mobile device through the mobile portal.

17. The system of claim 16, further comprising a mobile content database and the user and content management unit is further operative to store the channel content in the mobile content database.

18. The system of claim 17, wherein the user and content management unit is operative to receive uploaded content from the web portal and store the uploaded content into the mobile content database.

19. The system of claim 19, wherein the crawler is further operative to search the mobile content database.

20. The system of claim 16, wherein the user and content management unit is further operative to request the crawler to search for updated content for a defined channel.
